(19) United States
(12) Patent Application Publication
(10) Pub. No.: US 2021/0221094 A1
(43) Pub. Date: Jul. 22, 2021

(54) MULTIAXIAL PRODUCT HAVING AT LEAST TWO 0° LAYERS

(71) Applicant: TEIJIN CARBON EUROPE GMBH, Wuppertal (DE)

(72) Inventors: Ronny WOCKATZ, Höchstadt (DE); Johannes REHBEIN, Solingen (DE)

(73) Assignee: TEIJIN CARBON EUROPE GMBH, Wuppertal (DE)

(21) Appl. No.: 15/734,444

(22) PCT Filed: May 29, 2019
(86) PCT No.: PCT/EP2019/064032

§ 371 Date: Dec. 2, 2020

(30) Foreign Application Priority Data
Jun. 7, 2018 (EP) 18176535.5

(51) Int. Cl. B32B 5/08; B32B 5/26; B32B 15/02; B32B 5/10; B32B 7/09; B32B 15/20; B32B 5/12; B32B 5/02; B29C 70/22; B32B 15/14

(52) U.S. Cl. CPC B32B 5/08; B32B 2250/20; B32B 15/02; B32B 5/10; B32B 7/09; B32B 15/20; B32B 5/12; B32B 5/022; B29C 70/228; B32B 15/14; B32B 2262/0253; B32B 2262/101; B32B 2262/106; B32B 2260/021; B32B 2250/03; B32B 2307/52; B32B 2262/0269; B32B 5/26

(57) ABSTRACT

A multiaxial product including at least three thread layers, each of the thread layers being formed by multi-filament reinforcing yarns which are arranged within thread layers so as to be mutually parallel and next to one another so as to be adjacent, at least two thread layers being arranged within multiaxial product wherein thread layers define a 0° direction within multiaxial product and the at least one further thread layer being arranged at an angle of more than±10° with respect to 0° direction within multiaxial product, the at least two thread layers in 0° direction directly following one after the other, based on relative arrangement of the at least three thread layers within multiaxial product, without a further layer of multi-filament reinforcing yarns therebetween. Further, a method for producing multiaxial product, further relating to composite produced from multiaxial product and to a method for producing composite from multiaxial product.

The invention relates to a multiaxial product comprising at least three thread layers.

Multiaxial products have been known for a long time.

EP 2547816 or EP 2547510, for example, describe multiaxial products which have a plurality of layers with different angles to one another within the multiaxial product.

A disadvantage of the known multiaxial products, however, is that mechanical properties of the multiaxial products can only be adjusted to a small extent. For example, the pressure application of the multiaxial product in the 0° direction is strongly dependent on the surface weight of the thread layer in the 0° direction. The increase in the surface weight would result in an improvement of the mechanical properties. However, the surface weight cannot be increased without problems. A high surface weight frequently results in a fibre deviation or fibre condensing within the layer (so-called undulation), as a result of which the thread layer or its neighbouring layers contain a corrugation. The corrugation in turn reduces the mechanical properties of the thread layer.

From EP 3023241 is known a fibre-reinforced material which can be constructed of tape material and the different layers of which are deposited at angles to one another. According to this document, the tapes are provided arranged spaced from one another (they form separation channels). Thus, the mechanical property of the material is influenced, since yarn-free regions result.

It is therefore the task of the present invention to provide a multiaxial product which can be better adapted to mechanical properties.

This task is solved by a multiaxial product having at least three thread layers, wherein each of the thread layers is formed by multi-filament reinforcing yarns which are arranged within the thread layers so as to be mutually parallel and next to one another so as to be adjacent, wherein at least two thread layers are arranged within the multiaxial product such that they define a 0° direction within the multiaxial product and wherein the at least one further thread layer is arranged at an angle of more than±10° with respect to the 0° direction within the multiaxial product, wherein the at least two thread layers in the 0° direction follow directly one after the other, based on the relative arrangements of the at least three thread layers within the multiaxial product, without a further layer of multi-filament reinforcing yarns therebetween.

By using at least two thread layers in the 0° direction which follow directly one after the other within the multiaxial product (without any further layer of multi-filament reinforcing yarns as a thread layers therebetween), the mechanical properties of the multiaxial product can be advantageously influenced. For example, the at least two thread layers in the 0° direction can be constructed of different multi-filament reinforcing yarns, wherein the different yarn types are not able, or are able only to a small extent, to negatively influence one another, since they are not present within one layer.

The at least one further thread layers at an angle of more than±10° to the 0° direction within the multiaxial product preferably has an angle of±30°,±45°,±60° and/or 90° to the 0° direction within the multiaxial product. The at least one further thread layer at an angle of more than±10° to the 0° direction is however not a thread layer which was actually supposed to be deposited in the 0° direction and was deposited at an angle deviating slightly from the 0° direction only by reason of imprecisions. The at least one further thread layer at an angle of more than±10° to the 0° direction will be described hereinafter also only as at least one further thread layer.

For clarification purposes: the multiaxial product can comprise a multiplicity of thread layers made of multi-filament reinforcing yarns. According to the invention, however, no layers (that is also no further thread layers), made of multi-filament reinforcing yarns having an angle of at least±10° to the 0° layer, lie between the at least two thread layers which form the 0° layers. Between the thread layers in the 0° direction, as a result, are able to lie only so-called interim layers, such as for example nonwoven layers. Each layer which have fibres with a strength of less than 2000 MPa and/or a predominantly non-parallel fibre arrangement within the layer (e.g. nonwovens, randomly oriented fibre layers) should in this regard be considered as an interim layer.

The thread layers consist preferably of spread multi-filament reinforcing yarns which can also be described as tapes. The tapes preferably have a width from 80 to 800 mm, especially preferably the tapes have a width of between 250 and 360 mm and most especially preferably from 600 to 700 mm. For producing the thread layers, the spread multi-filament reinforcing yarns are deposited such that there are substantially no holes (yarn-free regions) within the thread layer. The multi-filament reinforcing yarns lie as a result in a hole-free manner upon one another. In a further preferred embodiment, the at least three thread layers consist of respectively one unidirectional fabric. In the unidirectional fabric, the multi-filament reinforcing yarns are arranged also spread, mutually parallel and next to one another so as to be adjacent, but are however interwoven with auxiliary yarns in order to increase the stability of the layers. As auxiliary yarns, bicomponent hotmelt adhesive yarns with a titre of 200 dtex can for example be used.

Preferably, the at least two thread layers in the 0° direction stand in direct contact to one another in the multiaxial product. A “direct contact” is here supposed to denote that the at least two thread layers in the 0° direction in the multiaxial product rest upon one another without any further interim layer (also without nonwoven) between the at least two thread layers in the 0° direction.

Preferably, the at least two thread layers in the 0° direction have in each case a surface weight of at least 100 g/m², more preferably of at least 150 g/m² and especially preferably of at least 180 g/m². In a preferred embodiment, all thread layers in the 0° direction have the same surface weight. However, it would also be conceivable for the at least two thread layers in the 0° direction to have different surface weights. Since at least two thread layers in the 0° direction are used for the multiaxial product, advantageously high surface weights can be achieved in the 0° direction, such that for example the compressive strength in the 0° direction is increased. In comparison to the use of one single layer with high surface weight, however, the advantage results that for example a thread undulation does not take place or takes place only slightly in the individual thread layers in the 0° direction or their adjacent layers.

Preferably, the at least one further thread layer has a surface weight of at least 100 g/m², especially preferably of at least 120 g/m². When using a plurality of such further thread layers, all thread layers can have in each case the same surface weight or have different surface weights.

Preferably, the at least three thread layers have as multi-filament reinforcing thread carbon-fibre, glass-fibre, aramid yarns and/or highly-extended UHMW-polyethylene yarns or mixtures of the said yarns. Especially preferably, the at least three thread layers consist up to at least 90% of the mentioned fibres or of the yarns or mixtures of the mentioned fibres or yarns.

In a preferred embodiment, the at least two thread layers in the 0° direction have the same fibre types or yarn type as the at least one further thread layer. The different thread layers can be identical or different with respect to the yarn titre employed.

Preferably, the multi-filament reinforcing yarns are carbon fibre yarns with a strength of at least 5000 MPa, measured according to AS-R-7608 and a modulus of tension of at least 260 GPa, measured according to AS-R-7608. With regard to this carbon fibre yarn employed, reference is made to the not yet published Japanese application with the file number JP 2017-231749. Further preferably, the multi-filament reinforcing yarns are carbon-fibre yarns with a strength of at least 4500 MPa, measured according to AS-R-7608 and a modulus of tension of at least 240 GPa, measured according to JIS-R-7608.

Preferably, the multiaxial product has at least one nonwoven layer. Preferably at least one nonwoven is arranged on, below and/or between the at least three thread layers. Especially preferably, a nonwoven is arranged between each thread layer and/or the multiaxial product has on the top side and/or on the bottom side in each case a further nonwoven. In this regard, it should become clear that a nonwoven can be arranged also between two thread layers in the 0° direction, which based on the relative arrangement of the at least three thread layers follow directly one after the other (in the multiaxial product), (apart from in the embodiment example in which the thread layers in the 0° direction contact one another directly). Further preferably, the multiaxial product has a powder binder. For example, a nonwoven can have a powder binder. Preferably, the at least one nonwoven has a surface weight of 3 to 25 g/m². In an embodiment with more than one nonwoven, all nonwoven layers used can have the same surface weight or different surface weights. An especially preferred construction of the multiaxial product results as follows:
at least one further thread layer
nonwoven
at least one further thread layer
nonwoven
thread layer in the 0° direction
nonwoven
thread layer in the 0° direction
nonwoven with powder binder

In an embodiment, the multiaxial product has a metal mesh. Preferably, the metal mesh is arranged on and/or below the at least three thread layers. Preferably, the metal mesh forms an outermost layer of the multiaxial product. Especially preferably, the metal mesh has a surface weight of 50 to 250 g/m², especially preferably from 70 to 175 g/m² and most especially preferably from 90 to 139 g/m². The metal mesh is preferably connected with one or several thread layers, for example by means of stitching or by means of a knit thread system which holds the multiaxial product together. By means of the metal mesh, the conductivity of the multiaxial product can advantageously be improved, which is particularly advantageous for applications in the field of aviation and space travel. Preferably, the metal mesh is a copper mesh.

Preferably, the at least one nonwoven consists of at least one first and one second thermoplastic polymer component, wherein the first and the second polymer components have different melting temperatures.

Preferably, the polymer component with the lower melting temperature has a melting temperature in the range between 80 and 135° C. and/or the polymer component with a higher melting temperature has a melting temperature in the range between 140 and 250° C.

Preferably, the first polymer component is soluble in epoxy, cyanate ester or benzoxazine matrix resins or in mixtures of these matrix resins and the second polymer component is insoluble in epoxy, cyanate ester or benzoxazine matrix resins or in mixtures of these matrix resins.

In an embodiment, the first polymer component is a polyamide and/or the nonwoven has an epoxide. Especially preferably, the epoxide is present in the form of a powder binder which is strewn on the nonwoven and has been thermally connected therewith.

Inasmuch as a binding material is used in some embodiment in particulate form, the preferred particle size is in a range from 50-160 μm, especially preferably between 80-140 μm.

It is the case for all embodiments with nonwoven that, if more than one nonwoven layer is used, in each case different nonwovens or the same nonwovens can be used for the multiaxial product. When using different nonwoven layers, the nonwoven layers can be different with respect to their surface weight, their material and/or their construction.

In comparison with the previously known multiaxial products, the proposed multiaxial product has the advantage of having an even thread pattern with, at the same time, a high fibre volume proportion, since the danger of undulation is reduced. Thereby, particularly the compressive strength of the multiaxial product can be increased. The proposed multiaxial product can in addition be more easily draped in comparison to multiaxial products with comparable surface weight but fewer thread layers, as well as by the use of previously pre-fixed 0° layers (e.g. as UD Tape, fixed by means of weft threads, powder binder or a thermoplastic mesh).

A further subject matter of the present invention relates to a method for producing a multiaxial product such as was previously described.

For producing the multiaxial product, at least three thread layers are deposited, wherein each of the thread layers is formed by multi-filament reinforcing yarns which are arranged within the thread layers so as to be mutually parallel and next to one another so as to be adjacent, wherein in the production of the multiaxial product at least two thread layers are deposited in a 0° direction, wherein on and/or below all of the at least two thread layers in the 0° direction is deposited at least one further thread layer at an angle of more than±10° with respect to the 0° direction within the multiaxial product.

The at least three thread layers for producing the multiaxial product can be formed first during the production of the multiaxial product (online) or be deposited already as pre-fabricated product (for example tape) for producing the multiaxial product in the production process as a finished layer (offline).

The at least two thread layers in the 0° direction are deposited upon one another without a further thread layer (with multi-filament reinforcing yarns arranged at an angle of more than±10° with respect to the 0° direction) therebetween. The at least one further thread layer can as a result be arranged on or below the at least two thread layers in the 0° direction. If more than one further thread layer is used, the further thread layers are located on and/or below the thread layers in the 0° direction, but never therebetween. When using more than one further thread layer, the multiaxial product thus produced can have a symmetrical construction about the at least two thread layers in the 0° direction. A symmetrical construction about the 0° direction is for example present in the case of a multiaxial product with the following construction:

+45°/0°/0°/−45°

Preferably, when producing the multiaxial product, at least one nonwoven layer is deposited between one of the thread layers. Preferably, nonwoven layers are deposited between all thread layers and/or as a last layer on one side or both sides on the outer thread layers. With respect to the nonwoven used as nonwoven layers, reference should be made to the already described embodiments regarding the nonwovens of the multiaxial product.

In an embodiment example, in addition a metal mesh can be deposited on an outer side of the multiaxial product. For the design of the metal mesh, reference is made to that which has already been written regarding the metal mesh of the multiaxial product.

In a preferred embodiment, each of the at least two thread layers deposited in the 0° direction is deposited by in each case one depositing device. When using already pre-fabricated thread layers, as a result one depositing device with a rolled-up thread layer is used for each thread layer in the 0° direction.

In another embodiment, the at least two thread layers in the 0° direction are generated by means of in each case one standing thread creel when producing the multiaxial product, when an online feed is provided.

In a further embodiment, the at least two thread layers in the 0° direction are deposited as so-called unidirectional fabric when producing the multiaxial product. During the production, each unidirectional fabric is then laid as a thread layer in the 0° direction preferably by its own depositing device in the manufacturing process.

A further subject matter of the present invention relates to a fibre-reinforced composite which contains at least one multiaxial product according to that which has just been described. Preferably, the composite has a multiplicity of thread layers of multi-filament reinforcing yarns and nonwoven layers therebetween. Especially preferably, the composite has a further or additional matrix material with which the thread layers and the nonwoven layers are impregnated.

A further subject matter of the present invention is thus also a method for producing the composite by means of an additional matrix material. Preferably, to this end, a multiplicity of multiaxial products of the initially mentioned sort are layered upon one another and consolidated by means of heat and pressure and an additional matrix material to form a component (composite). A composite of this sort can for example be used in the field of aviation and space travel or in the automotive field as a component.

1. A multiaxial product comprising at least three thread layers, wherein each of the thread layers is formed by multi-filament reinforcing yarns which are arranged within the thread layers so as to be mutually parallel and next to one another so as to be adjacent, wherein at least two thread layers are arranged within the multiaxial product such that they define a 0° direction within the multiaxial product and wherein the at least one further thread layer is arranged at an angle of more than±10° with respect to the 0° direction within the multiaxial product, wherein the at least two thread layers in a 0° direction follow directly one after the other, based on the relative arrangement of the at least three thread layers within the multiaxial product, without a further layer of multi-filament reinforcing yarns therebetween.

2. The multiaxial product according to claim 1, wherein the at least two thread layers in the 0° direction contact one another directly in the multiaxial product.

3. The multiaxial product according claim 1, wherein the at least two thread layers in the 0° direction have in each case a surface weight of at least 150 g/m², preferably of at least 180 g/m².

4. The multiaxial product according to claim 1, wherein the at least one further thread layers arranged at an angle of more than±10° with respect to the 0° direction within the multiaxial product has in each case a surface weight of at least 100 g/m².

5. The multiaxial product according to claim 1, wherein the multi-filament reinforcing yarns are carbon-fibre, glass-fibre or aramid yarns or highly-extended UHMW-polyethylene yarns.

6. The multiaxial product according to claim 1, wherein the multi-filament reinforcing yarns are carbon fibre yarns with a strength of at least 5000 MPa, measured according to JIS-R-7608 and a modulus of tension of at least 260 GPa, measured according to JIS-R-7608, and/or carbon fibre yarns with a strength of at least 4500 MPa, measured according to JIS-R-7608 and a modulus of tension of at least 240 GPa, measured according to JIS-R-7608.

7. The multiaxial product according to claim 1, wherein on, below and/or between the at least three thread layers is arranged at least one nonwoven and/or at least one metal mesh is arranged on and/or below the at least three thread layers.

8. The multiaxial product according to claim 7, wherein the at least one nonwoven has a surface weight in the range between 3 and 25 g/m² and/or the metal mesh has a surface weight of 60-200 g/m².

9. The multiaxial product according to claim 7, wherein the at least one nonwoven consists of at least one first and one second thermoplastic polymer component, wherein the first and the second polymer components have different melting temperatures.

10. The multiaxial product according to claim 9, wherein the polymer component with a lower melting temperature has a melting temperature in the range between 80 and 135° C. and/or the polymer component with a higher melting temperature has a melting temperature in the range between 140 and 250° C.

11. The multiaxial product according to claim 9, wherein the first polymer component is a polyamide and/or the nonwoven has an epoxide.

12. The multiaxial product according to claim 10, wherein the first polymer component is soluble in epoxy, cyanate ester or benzoxazine matrix resins or in mixtures of these matrix resins and the second polymer component is insoluble in epoxy, cyanate ester or benzoxazine matrix resins or in mixtures of these matrix resins.

13. The multiaxial product according claim 1, wherein the at least one nonwoven has a binding material in particulate form, wherein the particle size of the binding material is between 50-160 μm.

14. A fibre-reinforced composite, wherein the composite has at least one multiaxial product according to claim 1.

15. A method for producing a multiaxial product according to claim 1 from at least three thread layers, wherein each of the thread layers is formed by multi-filament reinforcing yarns which are arranged within the thread layers so as to be mutually parallel and next to one another so as to be adjacent, wherein during the production of the multiaxial product at least two thread layers are deposited in a 0° direction, wherein on or below all of the at least two thread layers in the 0° direction is deposited at least one further thread layer at an angle of more than±10° with respect to the 0° direction within the multiaxial product.

16. The method according to claim 15, wherein on, below and/or between the at least three thread layers is deposited at least one nonwoven.

17. The method according to claim 15, wherein each of the at least two thread layers deposited in the 0° direction is deposited by in each case one depositing device.

18. The method according to claim 15, wherein the multiaxial product further includes an additional matrix material.

19. The method according to claim 16, wherein each of the at least two thread layers deposited in the 0° direction is deposited by in each case one depositing device.
